(19) United States
(12) Patent Application Publication
(10) Pub. No.: US 2025/0062392 A1
(43) Pub. Date: Feb. 20, 2025

(54) SOLID ELECTROLYTE COMPOSITION, SOLID ELECTROLYTE LAYER, ELECTRODE, AND BATTERY

(71) Applicant: Panasonic Intellectual Property Management Co., Ltd., Osaka (JP)

(72) Inventors: YOHEI HAYASHI, Osaka (JP); YUTA SUGIMOTO, Hyogo (JP)

(21) Appl. No.: 18/935,668

(22) Filed: Nov. 4, 2024

Related U.S. Application Data
(63) Continuation of application No. PCT/JP2023/000170, filed on Jan. 6, 2023.

(30) Foreign Application Priority Data
May 20, 2022 (JP) 2022-083417

(51) Int. Cl. H01M 10/056; H01M 10/052

(52) U.S. Cl. CPC H01M 10/056; H01M 10/052; H01M 2300/0028

(57) ABSTRACT

A solid electrolyte composition includes a solid electrolyte and an organic solvent, in which the solid electrolyte contains I, and the organic solvent is a compound having an I-containing skeleton structure. A solid electrolyte layer includes an I-containing solid electrolyte and an organic compound that has a composition different from the solid electrolyte and has an I-containing skeleton structure. An electrode includes an I-containing solid electrolyte, an organic compound that has a composition different from the solid electrolyte and has an I-containing skeleton structure, and an active material.

### BACKGROUND

### 1. Technical Field

The present disclosure relates to a solid electrolyte composition, a solid electrolyte layer, an electrode, and a battery.

### 2. Description of the Related Art

International Publication No. 2018/025582 discloses a battery that uses a halide solid electrolyte.

### SUMMARY

One non-limiting and exemplary embodiment provides a solid electrolyte composition suitable for reducing the decrease in ion conductivity of a solid electrolyte.

In one general aspect, the techniques disclosed here feature a solid electrolyte composition containing a solid electrolyte and an organic solvent, in which the solid electrolyte contains I, and the organic solvent is a compound having an I-containing skeleton structure.

According to the present disclosure, a solid electrolyte composition suitable for reducing the decrease in ion conductivity of a solid electrolyte can be provided.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a flowchart indicating one example of a method for producing a solid electrolyte member according to a second embodiment;

FIG. 2 is a schematic diagram of a pressure-forming die 200 used to evaluate the ion conductivity retention rate of a solid electrolyte;

FIG. 3 is a graph indicating a Cole-Cole plot obtained by impedance measurement on the solid electrolyte material in Example 1; and

FIG. 4 is a graph indicating the results of a charge-discharge test of a battery of Example 1.

### DETAILED DESCRIPTIONS

### Underlying Knowledge Forming Basis of the Present Disclosure

In the field of secondary batteries where there is demand for higher energy density and higher capacity, it has been the mainstream practice to use organic electrolyte solutions obtained by dissolving electrolyte salts in organic solvents. A possible issue with a secondary battery that uses an organic electrolyte solution is the solution leakage, and the possibility of the increased heat quantity in the event of short-circuiting, etc., has been pointed out.

Meanwhile, all-solid secondary batteries that use inorganic solid electrolytes instead of organic electrolyte solutions are drawing much attention. All-solid secondary batteries do not cause solution leakage. Since inorganic solid electrolytes have no combustibility, heat generation in the event of short-circuiting or the like is also expected to be less.

As the inorganic solid electrolyte used in all-solid secondary batteries, there are known sulfide solid electrolytes that contain sulfur as a main component and oxide solid electrolytes that contain metal oxide as a main component. However, sulfide solid electrolytes have a disadvantage in that toxic hydrogen sulfide would be generated when reacted with water, and oxide solid electrolytes have a disadvantage in that the ion conductivity is low. Thus, development of a novel solid electrolyte having high ion conductivity is highly anticipated.

A prospective new solid electrolyte is a halogen solid electrolyte that contains, for example, lithium, yttrium, and iodine.

For practical application of an all-solid secondary battery that uses a solid electrolyte, the technology of preparing a flowable composition containing a solid electrolyte and applying this composition to a surface of an electrode or a current collector to form a solid electrolyte member is necessary.

To prepare a flowable composition, the solid electrolyte needs to be mixed with an organic solvent. Thus, the present inventors have studied the resistance of iodine-containing halogen solid electrolytes against various organic solvents. As a result, it has been found that mixing an iodine-containing halogen solid electrolyte with a particular organic solvent decreases the lithium ion conductivity of the iodine-containing halogen solid electrolyte in some cases. For example, an organic solvent that can be used in a sulfide solid electrolyte or an iodine-free halogen solid electrolyte cannot always be used in an iodine-containing solid electrolyte due to the decrease in ion conductivity. From these perspectives, the features of the present disclosure are conceived.

### Summary of Some Aspects of the Present Disclosure

A solid electrolyte composition according to a first aspect of the present disclosure contains:
a solid electrolyte; and
an organic solvent,
in which the solid electrolyte contains I, and
the organic solvent is a compound having an I-containing skeleton structure.

According to the first aspect, a solid electrolyte composition suitable for reducing the decrease in ion conductivity of the solid electrolyte can be provided.

In a second aspect of the present disclosure, for example, the solid electrolyte in the solid electrolyte composition according to the first aspect may be substantially free of sulfur.

The solid electrolyte composition according to the second aspect has excellent safety.

In a third aspect of the present disclosure, for example, the solid electrolyte in the solid electrolyte composition according to the first or second aspect may have lithium ion conductivity and may further contain at least one selected from the group consisting of Mg, Ca, Sr, Ba, Zn, Sn, Al, Sc, Ga, Bi, Sb, Zr, Hf, Ti, Ta, Nb, W, Y, Gd, Tb, and Sm.

According to the third aspect, a solid electrolyte composition suitable for reducing the decrease in ion conductivity of the solid electrolyte can be provided.

In a fourth aspect of the present disclosure, for example, the solid electrolyte in the solid electrolyte composition according to any one of the first to third aspects may further contain at least one selected from the group consisting of F, Cl, and Br.

According to the fourth aspect, a solid electrolyte composition suitable for reducing the decrease in ion conductivity of the solid electrolyte can be provided.

In a fifth aspect of the present disclosure, for example, the solid electrolyte in the solid electrolyte composition according to any one of first to fourth aspects may further contain Y.

According to the fifth aspect, a solid electrolyte composition suitable for reducing the decrease in ion conductivity of the solid electrolyte can be provided.

In a sixth aspect of the present disclosure, for example, the solid electrolyte in the solid electrolyte composition according to any one of the first to fifth aspects may further contain Y and at least one selected from the group consisting of F, Cl, and Br.

According to the sixth aspect, a solid electrolyte composition suitable for reducing the decrease in ion conductivity of the solid electrolyte can be provided.

In a seventh aspect of the present disclosure, for example, the solid electrolyte in the solid electrolyte composition according to any one of the first to sixth aspects may contain Li, Y, Cl, Br, and I.

According to the seventh aspect, a solid electrolyte composition suitable for reducing the decrease in ion conductivity of the solid electrolyte can be provided.

According to an eighth aspect of the present disclosure, for example, the solid electrolyte in the solid electrolyte composition according to any one of the first to sixth aspects may be represented by formula LiₐY_{b}Cl_{c}Br_{d}Iₑ and a, b, c, d, and e may satisfy 2.5≤a≤3.1, b+1.0, 0≤c≤6, 0≤d≤6, 0≤e≤6, and c+d+e+6.

According to the eighth aspect, a solid electrolyte composition suitable for reducing the decrease in ion conductivity of the solid electrolyte can be provided.

According to a ninth aspect of the present disclosure, for example, the compound in the solid electrolyte composition according to any one of the first to eighth aspects may contain a compound having a chain structure.

According to the ninth aspect, the solid electrolyte can easily disperse in the organic solvent.

According to a tenth aspect of the present disclosure, for example, the compound in the solid electrolyte composition according to any one of the first to ninth aspect may contain a compound having a cyclic structure.

According to the tenth aspect, the solid electrolyte can easily disperse in the organic solvent.

In an eleventh aspect of the present disclosure, for example, the compound in the solid electrolyte composition according to any one of the first to tenth aspects may contain an aromatic compound.

According to the eleventh aspect, the solid electrolyte can easily disperse in the organic solvent.

In a twelfth aspect of the present disclosure, for example, the organic solvent in the solid electrolyte composition according to any one of the first to eleventh aspects may contain at least one selected from the group consisting of iodobutane, iodopentane, iodohexane, iodoheptane, iodooctane, iodocyclohexane, iodobenzene, 2-iodotoluene, and 3-iodotoluene.

According to the twelfth aspect, the solid electrolyte can easily disperse in the organic solvent.

In a thirteenth aspect of the present disclosure, for example, the solid electrolyte composition according to any one of the first to twelfth aspects may further contain a binder.

According to the thirteenth aspect, a solid electrolyte member in a homogeneous film form can be formed.

In a fourteenth aspect of the present disclosure, for example, the solid electrolyte composition according to any one of the first to thirteenth aspects may further contain an active material.

According to the fourteenth aspect, an electrode in a homogeneous film form can be formed.

A solid electrolyte layer according to a fifteenth aspect of the present disclosure includes
an I-containing solid electrolyte; and
an organic compound that has a composition different from the solid electrolyte and has an I-containing skeleton structure.

The solid electrolyte layer according to the fifteenth aspect can realize a battery that has improved charge-discharge efficiency.

An electrode according to a sixteenth aspect of the present disclosure includes:
an I-containing solid electrolyte;
an organic compound that has a composition different from the solid electrolyte and has an I-containing skeleton structure; and
an active material.

The electrode according to the sixteenth aspect can realize a battery that has improved charge-discharge efficiency.

A battery according to a seventeenth aspect of the present disclosure includes:
at lest one selected from the group consisting of the solid electrolyte layer according to the fifteenth aspect and the electrode according to the sixteenth aspect.

The battery according to the seventeenth aspect can realize improved charge-discharge efficiency.

A method for producing a solid electrolyte layer according to an eighteenth aspect of the present disclosure includes removing, from the solid electrolyte composition according to any one of the first to thirteenth aspects, the organic solvent.

According to the production method of the eighteenth aspect, a homogenous solid electrolyte layer that can improve the charge-discharge efficiency of a battery can be produced.

A method for producing an electrode according to a nineteenth aspect of the present disclosure includes removing, from the solid electrolyte composition according to the fourteenth aspect, the organic solvent.

According to the production method of the nineteenth aspect, a homogenous electrode that can improve the charge-discharge efficiency of a battery can be produced.

Embodiments of the present disclosure will now be described. The present disclosure is not limited to the embodiments below.

### First Embodiment

A solid electrolyte composition according to a first embodiment includes a solid electrolyte and an organic solvent. The solid electrolyte contains I, and the organic solvent is a compound having an I-containing skeleton structure.

According to this feature, the solid electrolyte composition according to the first embodiment can reduce the decrease in lithium ion conductivity of a solid electrolyte. Thus, when a solid electrolyte member is produced by using this solid electrolyte composition, a solid electrolyte member having high lithium ion conductivity can be produced. Examples of the solid electrolyte member include a solid electrolyte film which is a thin film made of a solid electrolyte, and an electrode that contains a solid electrolyte. The solid electrolyte film may be, for example, a solid electrolyte layer of a battery.

The solid electrolyte composition may be in a paste form or in a dispersion state. The solid electrolyte is, for example, in a particle form. In the solid electrolyte composition, the particles of the solid electrolyte are mixed with an organic solvent. The viscosity of the solid electrolyte composition is adjusted as appropriate. For example, when a spraying method is employed to apply the composition, the viscosity of the solid electrolyte composition is relatively low. For example, when a method such as a doctor blade method is employed to apply the composition, the viscosity of the solid electrolyte composition is relatively high.

The ratio of the mass of the solid electrolyte to the total of the mass of the solid electrolyte and the mass of the organic solvent is not particularly limited and may be less than or equal to 70 mass %. According to this feature, a solid electrolyte composition that can be easily applied to a surface of an electrode or a current collector can be obtained.

The solid electrolyte and the organic solvent will now be described in detail.

### Solid Electrolyte

The solid electrolyte contains iodine or I. In other words, the solid electrolyte is an iodine-containing halide solid electrolyte. The solid electrolyte can have, for example, lithium ion conductivity.

The solid electrolyte may be substantially free of sulfur. The meaning of the phrase “the solid electrolyte is substantially free of sulfur” is that the sulfur content in the solid electrolyte is less than or equal to 1 mol %. For example, when the solid electrolyte contains Li, the ratio of the number of moles of S to the number of moles of Li in the solid electrolyte, the ratio S/Li, may be greater than or equal to 0 and less than or equal to 0.01. The solid electrolyte may be free of sulfur except as an inevitable impurity. A solid electrolyte free of sulfur does not generate hydrogen sulfide even when exposed to air and offers excellent safety.

The solid electrolyte may have lithium ion conductivity and may contain at least one selected from the group consisting of Mg, Ca, Sr, Ba, Zn, Sn, Al, Sc, Ga, Bi, Sb, Zr, Hf, Ti, Ta, Nb, W, Y, Gd, Tb, and Sm.

The solid electrolyte may further contain at least one selected from the group consisting of F, Cl, and Br.

According to the aforementioned feature, the solid electrolyte composition can further reduce the decrease in lithium ion conductivity of the solid electrolyte. Thus, when a solid electrolyte member is produced by using the solid electrolyte composition, a solid electrolyte member having higher lithium ion conductivity can be produced.

The solid electrolyte may further contain Y.

The solid electrolyte may further contain Y and at least one selected from the group consisting of F, Cl, and Br.

According to the aforementioned feature, the solid electrolyte composition can further reduce the decrease in lithium ion conductivity of the solid electrolyte. Thus, a solid electrolyte member having higher lithium ion conductivity can be produced.

The solid electrolyte may contain Li, Y, Cl, Br, and I.

The solid electrolyte may be represented by formula LiₐY_{b}Cl_{c}Br_{d}Iₑ and a, b, c, d, and e may satisfy 0<a<6, 0<b<2, 0≤c≤6, 0≤d≤6, 0≤e≤6, and c+d+e=6. In the formula above, a, b, c, d, and e may satisfy 2.5≤a≤3.1, b=1.0, 0≤c≤6, 0≤d≤6, 0≤e≤6, and c+d+e+6.

According to the aforementioned feature, the solid electrolyte composition can further reduce the decrease in lithium ion conductivity of the solid electrolyte. Thus, a solid electrolyte member having higher lithium ion conductivity can be produced.

The solid electrolyte in the solid electrolyte composition according to the first embodiment is produced as follows, for example.

Raw material powders are prepared and mixed into a target composition. The raw material powders may be, for example, halides, oxides, or hydroxides.

For example, when the target composition is Li₃YBr₂Cl₂I₂, a LiBr raw material powder, a LiI raw material powder, an YBr₃ raw material powder, and a YCl₃ raw material powder are mixed so that the molar ratio is LiBr:LiI:YBr₃:YCl₃=0.250:0.500:0.0833:0.167. The raw material powders may be mixed in a preadjusted molar ratio so as to cancel out the compositional changes that could occur during the synthetic process.

The raw material powders are mechanochemically (in other words, by a mechanochemical milling method) reacted with one another in a mixing device such as a planetary ball mill so as to obtain a mixture.

Alternatively, the raw material powders may be heat-treated in vacuum or in a dry argon atmosphere after the raw material powders are mixed.

A solid electrolyte in the solid electrolyte composition of the first embodiment is obtained by these methods.

### Organic Solvent

The organic solvent is a compound having an I-containing skeleton structure. Iodine that forms the skeleton of the organic solvent can suppress the reaction between iodine in the halide solid electrolyte and the organic solvent. As a result, the solid electrolyte is likely to keep the structure stably even when the solid electrolyte is dispersed in this organic solvent. As a result, a solid electrolyte composition that can reduce the decrease in ion conductivity of the solid electrolyte can be obtained. The organic solvent may be a mixed solvent obtained by mixing multiple compounds each having an I-containing skeleton structure. Hereinafter, the “compound having an I-containing skeleton structure” is referred to as a compound A.

In the compound A, the segments other than iodine may be composed solely of carbon and hydrogen. In other words, the compound A may be a compound in which at least one hydrogen atom in a hydrocarbon is substituted with an iodine atom. In other words, the compound A may contain at least one iodine atom covalently bonded to a carbon atom.

The compound A may contain a compound having a chain structure. The compound A may contain a compound having a straight chain structure. By using a compound having a straight chain structure as the organic solvent, a solid electrolyte composition having excellent solid electrolyte suspension stability can be obtained.

The number of carbon atoms contained in the compound A is not particularly limited and may be greater than or equal to 7. In this manner, the compound A is less volatile, and thus a solid electrolyte composition can be stably produced. Furthermore, the compound A can form a large molecular weight. In other words, the compound A can have a high boiling point.

The compound A may contain a compound having a cyclic structure. The compound A may contain a compound having an aromatic ring. The cyclic structure may be an alicyclic hydrocarbon or an aromatic hydrocarbon. The cyclic structure may be monocyclic or polycyclic. When a compound having a cyclic structure is used as the organic solvent, the solid electrolyte easily disperses in the organic solvent. From the viewpoint of increasing the solid electrolyte suspension stability in the solid electrolyte composition, the compound A may contain an aromatic compound. The compound A may be an aromatic compound.

The compound A may contain only iodine as the functional group. When such a compound is used as the organic solvent, the solid electrolyte easily disperses in the solid electrolyte composition. Thus, a solid electrolyte composition having excellent solid electrolyte suspension stability can be obtained. As a result, the solid electrolyte composition has excellent lithium ion conductivity and can form a denser solid electrolyte member. When such a compound is used, the solid electrolyte composition can easily form a dense solid electrolyte film having few pinholes, irregularities, etc.

The organic solvent may contain at least one selected from the group consisting of iodobutane, iodopentane, iodohexane, iodoheptane, iodooctane, iodocyclohexane, iodobenzene, 2-iodotoluene, and 3-iodotoluene. That is, more specifically, the compound A may contain at least one selected from the group consisting of iodobutane, iodopentane, iodohexane, iodoheptane, iodooctane, iodocyclohexane, iodobenzene, 2-iodotoluene, and 3-iodotoluene. According to this feature, the solid electrolyte can easily disperse in the organic solvent.

The number of iodine atoms contained in the compound A is not particularly limited. The number of iodine atoms contained in the compound A may be 1 or more than 1.

The boiling point of the organic solvent is not particularly limited and may be higher than or equal to 100° C. and lower than or equal to 250° C. The organic solvent may be liquid at 25° C. Such an organic solvent does not easily volatilize at room temperature, and thus a solid electrolyte composition can be stably produced. Thus, a solid electrolyte composition that can be easily applied to a surface of an electrode or a current collector can be obtained. Furthermore, such an organic solvent can be easily removed by drying. The organic solvent may be any liquid that can disperse the solid electrolyte, and the solid electrolyte does not have to be completely dissolved in the organic solvent.

The compound A constituting the organic solvent may be free of a heteroatom, for example. According to this feature, the solid electrolyte can easily disperse in the organic solvent. Examples of the heteroatom are N, P, O, and S.

The value δp of the polarity term of the Hansen solubility parameter (HSP) of the compound A is not limited to a particular value. The HSP is a parameter that indicates the solubility property between substances. In the present disclosure, the HSP means a parameter of the vector quantity obtained by resolving the Hildebrand solubility parameter into three cohesive energy components: the London dispersive force, the dipole-dipole force, and the hydrogen bond. In the present disclosure, the component corresponding to the dipole-dipole force of HSP is recited as the polarity term δp. The unit of δp is, for example, MPa^{1/2}. The value of the HSP of the compound A can be obtained by referring to a database, for example. When the compound does not have its HSP value registered in a database, the HSP value can be calculated from the chemical structure of the compound by using computer software such as Hansen Solubility Parameters in Practice (HSPIP).

The value of the polarity term δp of the HSP of the compound A is, for example, greater than or equal to 0 MPa^{1/2} and less than or equal to 12.0 MPa^{1/2}. In this manner, the solid electrolyte can easily disperse in the solid electrolyte composition.

According to the aforementioned features, the solid electrolyte composition can reduce the decrease in ion conductivity of the solid electrolyte. That is, when the solid electrolyte composition containing an iodine-containing solid electrolyte and the compound A serving as the organic solvent is dried to have the organic solvent removed therefrom, a solid electrolyte member having high ion conductivity can be obtained. The solid electrolyte member can be a solid electrolyte film.

### Other Components

The solid electrolyte composition may contain other components in addition to the aforementioned solid electrolyte and organic solvent.

The solid electrolyte composition may further contain a solvent other than the aforementioned organic solvent. For example, the amount of this solvent may be less than or equal to 50 volume % relative to the aforementioned organic solvent.

The solid electrolyte composition may further contain a binder.

Presence of a binder increases the binding between particles when the organic solvent is removed from the solid electrolyte composition.

Examples of the binder includepolyvinylidene fluoride, polytetrafluoroethylene, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene butadiene rubber, and carboxymethyl cellulose. Copolymers can also be used as the binder. For example, the binder is a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from those described above may also be used as a binder.

The solid electrolyte composition may further contain an active material. An active material is a material that can intercalate and deintercalate metal ions (for example, lithium ions).

When the solid electrolyte composition contains an active material and when the organic solvent is removed from the solid electrolyte composition, the resulting product can be used as an electrode of a battery. The solid electrolyte composition may contain a positive electrode active material or a negative electrode active material.

Examples of the positive electrode active material include lithium-containing transition metal oxides, transition metal fluorides, polyanion materials, fluorinated polyanion materials, transition metal sulfides, transition metal oxyfluorides, transition metal oxysulfides, and transition metal oxynitrides. Examples of the lithium-containing transition metal oxides include Li(Ni, Co, Al)O₂, LiCoO₂, and Li(Ni, Co, Mn)O₂. From the viewpoint of the battery energy density, a desirable example of the positive electrode active material is Li(Ni, Co, Mn)O₂. Li(Ni, Co, Mn)O₂ enables charging and discharging at a potential greater than or equal to 4 V. In the present disclosure, “(A, B, C)” means “at least one selected from the group consisting of A, B, and C”. Here, A, B, and C each indicate an element.

Examples of the negative electrode active material include metal materials, carbon materials, oxides, nitrides, tin compounds, and silicon compounds. The metal material may be a single metal material or an alloy. Examples of the metal material include metallic lithium and lithium alloys. Examples of the carbon materials include natural graphite, coke, graphitizing carbon, carbon fibers, spherical carbon, synthetic graphite, and amorphous carbon. From the viewpoint of the capacity density, desirable examples of the negative electrode active material are silicon (Si), tin (Sn), silicon compounds, and tin compounds. By using an active material having a low average discharge voltage, such as graphite, as a negative electrode active material, the energy density of a battery can be improved.

In order to increase the electron conductivity, the solid electrolyte composition may contain a conductive additive.

Examples of the conductive additive include:
(i) graphites such as natural graphite and synthetic graphite;
(ii) carbon blacks such as acetylene black and Ketjen black;
(iii) conductive fibers such as carbon fibers or metal fibers;
(iv) carbon fluoride;
(v) metal powders such as aluminum;
(vi) conductive whiskers such as zinc oxide and potassium titanate;
(vii) conductive metal oxides such as titanium oxide; and
(viii) conductive polymer compounds such as polyaniline, polypyrrole, and polythiophene. For reducing the cost, conductive additives (i) or (ii) described above may be used.

### Second Embodiment

A second embodiment will now be described. The descriptions of features common to those in the first embodiment described above may be omitted as appropriate.

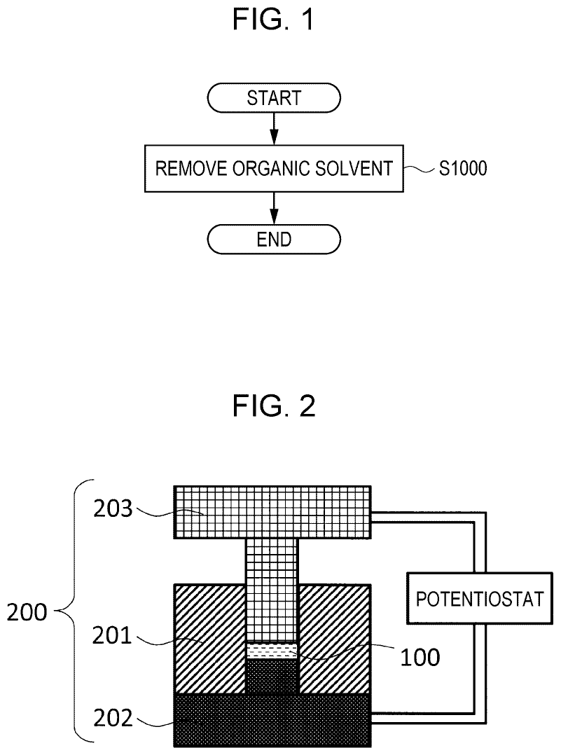

FIG. 1 is a flowchart indicating one example of a method for producing a solid electrolyte member according to the second embodiment. The production method according to the second embodiment produces a solid electrolyte member by using the solid electrolyte composition according to the first embodiment.

The method for producing a solid electrolyte member includes removing the organic solvent from the solid electrolyte composition according to the first embodiment (S1000). In the description below, the step of removing the organic solvent is referred to as the removal step.

A solid electrolyte member is produced by removing, from a solid electrolyte composition containing an iodine-containing solid electrolyte and an organic solvent, the organic solvent. As a result, the solid electrolyte member can gain high lithium ion conductivity. The solid electrolyte member is a member that contains a solid electrolyte. The solid electrolyte member may be, for example, a solid electrolyte film or an electrode that contains a solid electrolyte. According to the second embodiment, for example, a homogeneous solid electrolyte film can be produced. The solid electrolyte film may be, for example, a solid electrolyte layer of a battery.

Before the removal step S1000, the solid electrolyte composition may be applied to a substrate to form a film of the solid electrolyte composition. By removing the organic solvent from the film of the solid electrolyte composition, a homogeneous solid electrolyte film can be produced, for example. The substrate is not particularly limited. Examples of the substrate include electrodes and current collectors. When an electrode is used as the substrate and a solid electrolyte film is produced on the electrode, the produced solid electrolyte film can serve as a solid electrolyte layer of a battery. Moreover, when the solid electrolyte composition contains an active material, a homogeneous electrode can be produced.

In the removal step S1000, the organic solvent is removed from the solid electrolyte composition. Here, the organic solvent may be removed by reduced-pressure drying. The solid electrolyte composition before the removal of the organic solvent has flowability and thus excellent formability, and can form a coating film having an even thickness, for example. When such a coating film is dried, for example, a dense solid electrolyte film having few pinholes, irregularities, etc., can be easily obtained.

The reduced-pressure drying involves removing the organic solvent from the solid electrolyte composition in an atmosphere at a pressure lower than the atmospheric pressure. An atmosphere at a pressure lower than the atmospheric pressure is an atmosphere at a gauge pressure of less than or equal to −0.01 MPa. In the reduced-pressure drying, the solid electrolyte composition may be heated at an atmosphere temperature higher than or equal to 50° C. and lower than or equal to 250° C., for example. The organic solvent may be removed by vacuum drying. The vacuum drying involves removing the organic solvent from the solid electrolyte composition at a pressure lower than or equal to the steam pressure at a temperature 20° C. lower than the boiling point of the organic solvent, for example.

Removal of the compound A, that is, the organic solvent, can be confirmed by, for example, Fourier transform infrared spectroscopy (FT-IR), X-ray photoelectron spectroscopy (XPS), gas chromatography (GC), or gas chromatography mass spectrometry (GC/MS). Here, as long as the dried solid electrolyte member exhibits ion conductivity, the organic solvent does not have to be completely removed. In other words, the solid electrolyte member may contain a compound having an I-containing skeleton structure. The presence of this compound can be confirmed through FT-IR, XPS, GC, or GC/MS.

### Third Embodiment

A third embodiment will now be described. The descriptions of features common to those in the first and second embodiments described above may be omitted as appropriate.

The solid electrolyte member according to the third embodiment contains an I-containing solid electrolyte and an organic compound that has a composition different from the solid electrolyte and has an I-containing skeleton structure.

The solid electrolyte member according to the third embodiment can be obtained by the production method according to the second embodiment, for example. The solid electrolyte member according to the third embodiment can gain high lithium ion conductivity. The solid electrolyte member is a member that contains a solid electrolyte. The solid electrolyte member may be, for example, a solid electrolyte film or an electrode that contains a solid electrolyte. The solid electrolyte member according to the third embodiment may be a homogeneous solid electrolyte film. The solid electrolyte film may be, for example, a solid electrolyte layer of a battery.

The solid electrolyte member according to the third embodiment may be a solid electrolyte layer. The solid electrolyte layer contains the I-containing solid electrolyte and an organic compound that has a composition different from the solid electrolyte and has an I-containing skeleton structure.

The mass ratio of the organic compound in the solid electrolyte layer may be greater than or equal to 0.00001% and less than or equal to 5%.

The solid electrolyte layer may further contain a binder.

The solid electrolyte is, for example, a solid electrolyte described in the first embodiment. The organic compound is, for example, the compound A used as the organic solvent described in the first embodiment. The binder is, for example, a binder described in the first embodiment.

The solid electrolyte layer is, for example, produced by removing the organic solvent from the solid electrolyte composition according to the first embodiment. The solid electrolyte layer may be produced by pressure-forming the solid electrolyte composition with the organic solvent removed therefrom. The solid electrolyte layer may be produced by applying the solid electrolyte composition to a substrate and then removing the organic solvent from the applied solid electrolyte composition.

The solid electrolyte member according to the third embodiment may be an electrode. The electrode contains an I-containing solid electrolyte, the organic compound that has a composition different from the solid electrolyte and has an I-containing skeleton structure, and an active material.

The mass ratio of the organic compound in the electrode may be greater than or equal to 0.00001% and less than or equal to 5%.

The electrode may further contain a binder.

The solid electrolyte is, for example, a solid electrolyte described in the first embodiment. The organic compound is, for example, the compound A used as the organic solvent described in the first embodiment. The active material is, for example, an active material described in the first embodiment. The binder is, for example, a binder described in the first embodiment.

The electrode is, for example, produced by removing the organic solvent from the solid electrolyte composition according to the first embodiment. The electrode may be produced by applying the solid electrolyte composition according to the first embodiment to a substrate and then removing the organic solvent from the applied solid electrolyte composition.

### Fourth Embodiment

A fourth embodiment will now be described. The descriptions of features common to those in the first to third embodiments described above may be omitted as appropriate.

A battery according to the fourth embodiment includes at least one selected from the group consisting of the solid electrolyte layer according to the third embodiment and the electrode according to the third embodiment. In other words, the battery according to the fourth embodiment includes a positive electrode, a solid electrolyte layer, and a negative electrode arranged in this order, and at least one selected from the group consisting of (i) and (ii) below is satisfied:
(i) The solid electrolyte layer is the solid electrolyte layer according to the third embodiment; and
(ii) At least one selected from the group consisting of a positive electrode and a negative electrode is the electrode according to the third embodiment.

The battery according to the fourth embodiment is, for example, produced by using the solid electrolyte composition according to the first embodiment. Thus, improved charge-discharge efficiency can be realized.

In the battery according to the fourth embodiment, the solid electrolyte layer may be the solid electrolyte layer according to the third embodiment, the negative electrode may be the electrode according to the third embodiment, and the positive electrode may be the electrode according to the third embodiment. In the battery according to the fourth embodiment, the solid electrolyte layer may be the solid electrolyte layer according to the third embodiment, and the negative electrode may be the electrode according to the third embodiment. In the battery according to the fourth embodiment, the solid electrolyte layer may be the solid electrolyte layer according to the third embodiment, and the positive electrode may be the electrode according to the third embodiment.

### EXAMPLES

The present disclosure will now be described in detail by referring to Examples and Comparative Examples. In Examples, a powder obtained by removing the organic solvent from the solid electrolyte composition is referred to as a “solid electrolyte material”.

### Example 1

### Preparation of Solid Electrolyte Composition

In an Ar atmosphere having a dew point lower than or equal to −60° C., 300 mg of Li₃YBr₂Cl₂I₂ (hereinafter, referred to as LYBCI) serving as a solid electrolyte was weighed and placed in a commercially available glass screw tube. To the screw tube, 2 g of iodobenzene serving as the organic solvent was weighed and added, and the resulting mixture was stirred and mixed with an ultrasonic homogenizer to prepare a solid electrolyte composition of Example 1.

### Removing Organic Solvent by Drying

In an Ar atmosphere having a dew point lower than or equal to −60° C., the solid electrolyte composition was dried at 70° C. for 2 hours to remove the organic solvent. Removal of the organic solvent was visually determined. Thus, a solid electrolyte material was obtained.

In addition, GC/MS confirmed the presence of a trace amount of residual iodobenzene in the solid electrolyte material of Example 1.

### Evaluation of Ion Conductivity Retention Rate

FIG. 2 is a schematic diagram of a pressure-forming die 200 used to evaluate the ion conductivity retention rate of the solid electrolyte. As illustrated in FIG. 2, the pressure-forming die 200 is made of a die 201, an upper punch 203, and a lower punch 202. The die 201 is composed of an electron-insulating polycarbonate. The upper punch 203 and the lower punch 202 are composed of stainless steel.

The ion conductivity retention rate of the solid electrolyte was evaluated by the following method using the pressure-forming die 200 illustrated in FIG. 2.

In an Ar atmosphere having a dew point lower than or equal to −60° C., a powder 100 of the solid electrolyte material was packed in the pressure-forming die 200 and uniaxially formed at 360 MPa into a conductivity measurement cell composed of the powder of the solid electrolyte material.

While applying pressure, a conductor wire was extracted from each of the upper punch 203 and the lower punch 202. The conductor wires were connected to a potentiostat (VMP-300 produced by BioLogic) equipped with a frequency response analyzer. The lithium ion conductivity at 25° C. was measured by an electrochemical impedance measurement method.

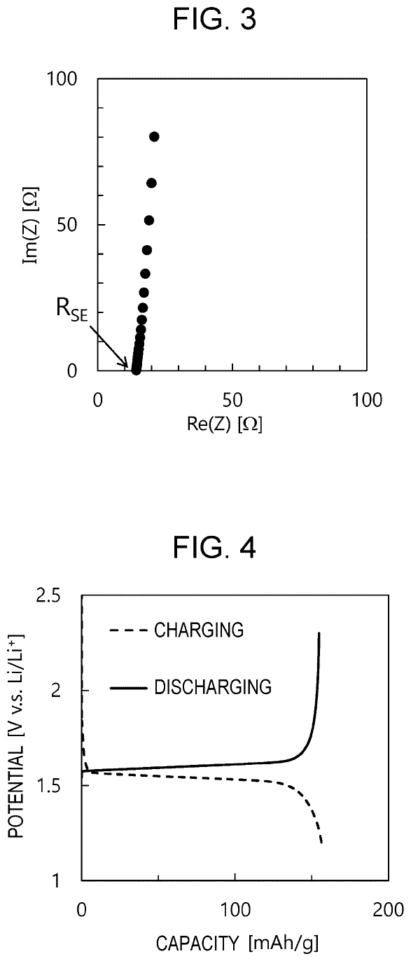

FIG. 3 is a graph indicating a Cole-Cole plot obtained by impedance measurement on the solid electrolyte material in Example 1. That is, FIG. 3 is a graph indicating a Cole-Cole plot obtained by impedance measurement on the solid electrolyte material in Example 1 subjected to the mixing and stirring with the organic solvent and drying.

In FIG. 3, the real value of the impedance at a measurement point having the smallest absolute value of the complex impedance phase was assumed to be the resistance value relative to the ion conductivity of the solid electrolyte material. See the arrow RSE indicated in the graph for this real value. The ion conductivity was calculated from equation (1) below by using this resistance value.

σ=(R_{SE}×S/t)⁻¹ (1):

Here, σ represents the ion conductivity. S represents the contact area between the solid electrolyte material and the upper punch 203 (in FIG. 2 this is equal to the cross-sectional area of a hollow portion of the die 201). R_{SE} represents the resistance value of the solid electrolyte material obtained by impedance measurement. Furthermore, t represents the thickness of the solid electrolyte material under pressure (in FIG. 2, this is equal to the thickness of the layer made of the powder 100 of the solid electrolyte material).

The lithium ion conductivity (σ₁) of the solid electrolyte (LYBCI) before mixing and stirring with the organic solvent and drying and the lithium ion conductivity (σ₂) of the solid electrolyte material after mixing and stirring with the organic solvent and drying were measured by the aforementioned method, and σ₂ was divided by σ₁ to calculate the ion conductivity retention rate of the solid electrolyte of Example 1. The result is indicated in Table 1.

### Preparation of Battery

In an Ar atmosphere having a dew point lower than or equal to −60° C., LYBCI and Li₄Ti₅O₁₂ (hereinafter, referred to as LTO) serving as a negative electrode active material were prepared at a mass ratio of LYBCI:LTO+35:65. In addition, a conductive additive (VGCF-H produced by Showa Denko K.K.) and a binder (G1651 produced by Kraton Corporation) were prepared so that, per 100 of LTO in terms of mass, the mass ratio of the conductive additive was 2.4 and the mass ratio of the binder was 0.8. These materials were dissolved or dispersed in the organic solvent, and the resulting mixture was stirred mixed with an ultrasonic homogenizer to obtain a negative electrode slurry.

In an Ar atmosphere having a dew point lower than or equal to −60° C., the obtained negative electrode slurry was applied to an Al foil and dried at 70° C. for 2 hours to prepare a negative electrode.

Into an insulating tube having an inner diameter of 9.5 mm, 90 mg of a solid electrolyte material was weighed and added, and a pressure of 160 MPa was applied thereto to form a solid electrolyte layer.

Next, the aforementioned negative electrode (10.78 mg) punched out into ϕ9.2 mm was layered on the solid electrolyte layer to obtain a multilayer body. A pressure of 720 MPa was applied to the multilayer body.

Next, a metallic Li foil (thickness: 300 μm) was layered on the solid electrolyte layer to obtain a multilayer body A pressure of 80 MPa was applied to the multilayer body to form a counter electrode.

Stainless steel current collectors were attached to the negative electrode and the counter electrode, and current collecting leads were attached to the current collectors.

Lastly, an insulating ferrule was used to block the interior of the insulating tube from the outside atmosphere to hermetically seal the interior of the tube. Thus, a battery of Example 1 was obtained.

### Charge-Discharge Measurement

FIG. 4 is a graph indicating the results of a charge-discharge test of a battery of Example 1. Here, the horizontal axis of the graph indicates the capacity per unit mass obtained by dividing the capacity of the battery by the mass of LTO in the negative electrode.

The charge-discharge characteristics were measured by the following procedure. Here, the battery prepared in Example 1 is a cell for charge-discharge testing, and corresponds to a half cell of the negative electrode. Thus, in the battery of Example 1, charging refers to a state in which electrical current flows in a direction in which lithium ions travel from the metallic Li (counter electrode) to the negative electrode containing LTO, that is, the direction in which the potential of the half cell decreases. In addition, in the battery of Example 1, discharging refers to a state in which electrical current flows in a direction in which lithium ions travel from the negative electrode containing LTO to metallic Li (counter electrode), that is, the direction in which the potential of the half cell increases. In other words, charging of the battery of Example 1 is substantially (in other words, in the case of a full cell) discharging, and the discharging of the battery of Example 1 is substantially charging.

The battery of Example 1 was placed in a constant-temperature vessel at 25° C.

The battery of Example 1 was charged at a current density of 58.7 μA/cm² until the voltage of the negative electrode relative to the counter electrode had reached 1.20 V. This current density corresponds to a 0.05 C rate (20-hour rate) with respect to the theoretical capacity of the battery.

Next, the battery of Example 1 was discharged at a current density of 58.7 μA/cm² until the voltage of the negative electrode relative to the counter electrode had reached 2.3 V. This current density corresponds to a 0.05 C rate (20-hour rate) with respect to the theoretical capacity of the battery.

### Example 2

A solid electrolyte material of Example 2 was obtained as in Example 1 except iodobutane was used as the organic solvent, and the ion conductivity retention rate was evaluated as in Example 1.

### Example 3

A solid electrolyte material of Example 3 was obtained as in Example 1 except that iodoheptane was used as the organic solvent, and the ion conductivity retention rate was evaluated as in Example 1.

### Reference Example 1

A solid electrolyte material of Reference Example 1 was obtained as in Example 1 except that no organic solvent was used, and the ion conductivity retention rate was evaluated as in Example 1. In other words, in Reference Example 1, the ion conductivity of LYBCI was assumed to be σ₁ and the ion conductivity after heating LYBCI at 70° C. for 2 hours was assumed to be σ₂ in calculating the ion conductivity retention rate.

### Comparative Example 1

A solid electrolyte material was obtained as in Example 1 except that heptane was used as the organic solvent, and the ion conductivity retention rate was evaluated as in Example 1. In addition, GC/MS confirmed the presence of a trace amount of residual heptane in the solid electrolyte material of Comparative Example 1.

### Comparative Example 2

A solid electrolyte material was obtained as in Example 1 except that p-chlorotoluene was used as the organic solvent, and the ion conductivity retention rate was evaluated as in Example 1. In addition, GC/MS confirmed the presence of a trace amount of residual p-chlorotoluene in the solid electrolyte material of Comparative Example 2.

### Comparative Example 3

A solid electrolyte material was obtained as in Example 1 except that mesitylene was used as the organic solvent, and the ion conductivity retention rate was evaluated as in Example 1.

### Comparative Example 4

A solid electrolyte material was obtained as in Example 1 except that cumene was used as the organic solvent, and the ion conductivity retention rate was evaluated as in Example 1.

### Comparative Example 5

A solid electrolyte material was obtained as in Example 1 except that dibutyl ether was used as the organic solvent, and the ion conductivity retention rate was evaluated as in Example 1.

### Comparative Example 6

A solid electrolyte material was obtained as in Example 1 except that tetralin was used as the organic solvent, and the ion conductivity retention rate was evaluated as in Example 1.

The results of Examples 2 and 3 and Reference Example 1 are indicated in Table 1. The results of Comparative Examples 1 to 6 are indicated in Table 2.

TABLE 1

| | | Iodine in | Ion |
|---|---|---|---|
| | | skeleton of | conductivity |
| | Organic | organic | retention |
| | solvent | solvent structure | rate |
| Example 1 | Iodobenzene | Present | 0.991 |
| Example 2 | Iodobutane | Present | 0.949 |
| Example 3 | Iodoheptane | Present | 0.867 |
| Reference | — | — | 0.906 |
| Example 1 | | | |

TABLE 2

| | | Iodine in | |
|---|---|---|---|
| | | skeleton of | Ion |
| | | organic | conductivity |
| | Organic | solvent | retention |
| | solvent | structure | rate |
| Comparative Example 1 | Heptane | Absent | 0.571 |
| Comparative Example 2 | p-Chlorotoluene | Absent | 0.522 |
| Comparative Example 3 | Mesitylene | Absent | 0.171 |
| Comparative Example 4 | Cumene | Absent | 0.176 |
| Comparative Example 5 | Dibutyl ether | Absent | 0.0568 |
| Comparative Example 6 | Tetralin | Absent | 0.406 |

Examples 1 to 3 exhibited high ion conductivity retention rates compared to Comparative Examples 1 to 6. The ion conductivity retention rates of Examples 1 to 3 were about the same as the ion conductivity retention rate of Reference Example 1. By using the organic solvents of Examples 1 to 3, the decrease in ion conductivity when a solid electrolyte material was prepared from a solid electrolyte composition was reduced.

The ion conductivity retention rates of Comparative Examples 1 to 6 were lower than the ion conductivity retention rate of Reference Example 1. In other words, when the organic solvents of Comparative Examples 1 to 6 were used, the decrease in ion conductivity of the solid electrolyte was not reduced. A possible reason therefor is that since the organic solvents used in Comparative Examples 1 to 6 were not a compound that has an I-containing skeleton structure, the organic solvent reacted with iodine contained in LYBCI and thus LYBCI was modified.

The battery that used the solid electrolyte material of Example 1 realized excellent charge-discharge characteristics.

The solid electrolyte composition according to the present disclosure can be used in producing an all-solid lithium secondary battery, for example.

What is claimed is:

1. A solid electrolyte composition comprising:
a solid electrolyte; and
an organic solvent,
wherein the solid electrolyte contains I, and
the organic solvent is a compound having an I-containing skeleton structure.

2. The solid electrolyte composition according to claim 1,
wherein the solid electrolyte is substantially free of sulfur.

3. The solid electrolyte composition according to claim 1,
wherein the solid electrolyte has lithium ion conductivity and contains at least one selected from the group consisting of Mg, Ca, Sr, Ba, Zn, Sn, Al, Sc, Ga, Bi, Sb, Zr, Hf, Ti, Ta, Nb, W, Y, Gd, Tb, and Sm.

4. The solid electrolyte composition according to claim 1,
wherein the solid electrolyte further contains at least one selected from the group consisting of F, Cl, and Br.

5. The solid electrolyte composition according to claim 1,
wherein the solid electrolyte further contains Y.

6. The solid electrolyte composition according to claim 1,
wherein the solid electrolyte further contains Y and at least one selected from the group consisting of F, Cl, and Br.

7. The solid electrolyte composition according to claim 1, wherein the solid electrolyte contains Li, Y, Cl, Br, and I.

8. The solid electrolyte composition according to claim 1,
wherein the solid electrolyte is represented by formula: LiₐY_{b}Cl_{c}Br_{d}Iₑ
where a, b, c, d, and e satisfy 2.5≤a≤3.1, b+1.0, 0≤c≤6, 0≤d≤6, 0≤e≤6, and c+d+e+6.

9. The solid electrolyte composition according to claim 1,
wherein the compound contains a compound having a chain structure.

10. The solid electrolyte composition according to claim 1,
wherein the compound contains a compound having a cyclic structure.

11. The solid electrolyte composition according to claim 1,
wherein the compound contains an aromatic compound.

12. The solid electrolyte composition according to claim 1,
wherein the organic solvent contains at least one selected from the group consisting of iodobutane, iodopentane, iodohexane, iodoheptane, iodooctane, iodocyclohexane, iodobenzene, 2-iodotoluene, and 3-iodotoluene.

13. The solid electrolyte composition according to claim 1,
further comprising a binder.

14. The solid electrolyte composition according to claim 1,
further comprising an active material.

15. A solid electrolyte layer comprising:
an I-containing solid electrolyte; and
an organic compound that has a composition different from the solid electrolyte and has an I-containing skeleton structure.

16. An electrode comprising:
an I-containing solid electrolyte;
an organic compound that has a composition different from the solid electrolyte and has an I-containing skeleton structure; and
an active material.

17. A battery comprising:
at least one selected from the group consisting of a solid electrolyte layer and an electrode, the solid electrolyte layer comprising: an I-containing solid electrolyte; and
an organic compound that has a composition different from the solid electrolyte and has an I-containing skeleton structure, the electrode comprising: an I-containing solid electrolyte; an organic compound that has a composition different from the solid electrolyte and has an I-containing skeleton structure; and an active material.

18. A method for producing a solid electrolyte layer, the method comprising:
removing, from the solid electrolyte composition according to claim 1, the organic solvent.

19. A method for producing an electrode, the method comprising:
removing, from the solid electrolyte composition according to claim 14, the organic solvent.
